(19) United States
(12) Patent Application Publication
(10) Pub. No.: US 2025/0280349 A1
(43) Pub. Date: Sep. 4, 2025

(54) TRANSCEIVER DEVICE AND OPERATION METHOD OF WIRELESS COMMUNICATION NETWORK

(71) Applicant: Realtek Semiconductor Corp., HsinChu (TW)

(72) Inventors: Shau-Yu Cheng, HsinChu (TW); Chia-Yu Hsu, HsinChu (TW); Wun-Ci Su, HsinChu (TW)

(73) Assignee: Realtek Semiconductor Corp., HsinChu (TW)

(21) Appl. No.: 19/049,005

(22) Filed: Feb. 10, 2025

(30) Foreign Application Priority Data
Mar. 1, 2024 (TW) 113107390

(51) Int. Cl. H04W 40/12; H04L 43/0894; H04W 28/02

(52) U.S. Cl. CPC H04W 40/12; H04L 43/0894; H04W 28/0273

(57) ABSTRACT

A transceiver device in a wireless communication network includes: a traffic measuring unit, for measuring a packet transmission rate of an application layer of the wireless communication network; a transmission path configuring unit, for configuring a transmission circuit number used by the wireless communication network; a statistic unit, coupled to the transmission path configuring unit, for performing a statistical operation to obtain an average packet error rate (PER) of the transceiver device during a first target beacon transmission time (TBTT); and a decision module, coupled to the traffic measuring unit, the transmission path configuring unit and the statistic unit, for controlling the transmission path configuring unit to decrease the transmission circuit number used by the wireless communication network during a second TBTT according to the packet transmission rate and the average PER.

### BACKGROUND OF THE INVENTION

### 1. Field of the Invention

The present invention relates to a wireless communication network mechanism, and more particularly, to a transceiver device and an operation method in a wireless communication network.

### 2. Description of the Prior Art

Designs of rates in current wireless communication networks only focus on how to maximize a transmission data throughput. More than one antenna for transmission is usually needed, which means that multiple transmission circuits must be activated. For an application that needs only a low throughput, this transmission method results in unnecessary power consumption.

### SUMMARY OF THE INVENTION

The present invention provides a transceiver device and an operation method in a wireless communication network to solve the abovementioned problem.

A transceiver device in a wireless communication network comprises: a traffic measuring unit, for measuring a packet transmission rate of an application layer of the wireless communication network; a transmission path configuring unit, for configuring a transmission circuit number used by the wireless communication network; a statistic unit, coupled to the transmission path configuring unit, for performing a statistical operation to obtain an average packet error rate (PER) of the transceiver device during a first target beacon transmission time (TBTT); and a decision module, coupled to the traffic measuring unit, the transmission path configuring unit and the statistic unit, for controlling the transmission path configuring unit to decrease the transmission circuit number used by the wireless communication network during a second TBTT according to the packet transmission rate and the average PER.

An operation method for a transceiver device in a wireless communication network, comprises: measuring a packet transmission rate of an application layer of the wireless communication network; configuring a transmission circuit number used by the wireless communication network; performing a statistical operation to obtain an average packet error rate (PER) of the transceiver device during a first target beacon transmission time (TBTT); and decreasing the transmission circuit number used by the wireless communication network during a second TBTT according to the packet transmission rate and the average PER.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block schematic diagram of a transceiver device in a wireless communication network according to an example of the present invention.

FIG. 2 is a schematic diagram of operations of a transceiver device according to an example of the present invention.

FIG. 3 is a schematic diagram of operations corresponding to the transceiver device in FIG. 1 according to an example of the present invention.

### DETAILED DESCRIPTION

The present invention provides a transceiver device in a wireless communication network (e.g., a wireless Wi-Fi network). The transceiver device is enabled to adaptively or dynamically adjust a transmission rate of the wireless communication network (i.e., a transmission rate model of the transmission rate) to adapt to the varying environment, so that a transmission performance of the wireless communication network meets user expectations. In the following paragraphs, the terms “transmission rate” and “transmission rate model” are simplified to the terms “rate” and “rate model”, respectively, for brevity.

The transceiver device in the present invention is enabled to perform transmissions according to a rate (i.e., a rate model corresponding to the rate) with a low transmission power and a high robustness in the case of maximizing a throughput, to achieve a power saving rate adaptation (PS-RA).

Specifically, the transceiver device and a related algorithm mechanism in the present invention use a PS-RA mechanism within a reasonable scope according to a packet transmission rate of an application layer of the wireless communication network (i.e., a packet generation rate of the application layer), to select a suitable rate and activate a part of transmission circuits. In other words, the transceiver device in the present invention considers the packet transmission rate of the application layer to determine whether to use the PS-RA mechanism. When using the PS-RA mechanism, the transceiver device ensures that a data transmission throughput achieved by the transceiver device is the same as (or close to) a data transmission throughput achieved by a rate adaptation (RA) mechanism which maximizes the throughput, and simultaneously ensures that the PER does not become worse. At this time, an appropriate rate is selected and only part of the transmission circuits needs to be activated, to save power. In contrast, when detecting that the packet transmission rate of the application layer is too fast, the transceiver device closes and deactivates the PS-RA mechanism and adopts the RA mechanism which maximizes the throughput, to maintain a best user experience.

In addition, in one example, in order to speed up the selection of the suitable rate or rate model, the transceiver device and the related algorithm mechanism in the present invention measure channel conditions or channel statuses of the wireless communication network to establish a rate candidate table, so that the PS-RA mechanism selects the suitable rate from the rate candidate table. For example, the transceiver device establishes the rate candidate table in advance according to different channel statuses. Multiple (e.g., 3, but not limited to) suitable candidate rates are given for each channel status, to reduce a number of times trial transmissions are performed.

By looking up the rate candidate table, a corresponding candidate rate used by the PS-RA mechanism is found as a trial rate and it is determined whether the trial rate is used for replacing a given rate. The given rate needs more than one spatial stream (a number of the spatial streams of the given rate being greater than one means that a rate model of the given rate needs more than one transmission circuit to perform transmissions). In addition, the time for performing successive trial transmissions according to all rates is greatly reduced due to the limited number N (e.g., 3) of candidate rates. A selected candidate rate is a best candidate rate among N (e.g., 3) candidate rates.

Furthermore, the transceiver device in the present invention also considers different channel conditions, so that a packet error rate (PER) corresponding to a rate finally selected by the transceiver device and used for transmissions is not higher than a PER corresponding to a rate of the maximum throughput. In addition, different rates in the rate candidate table are obtained by adopting the RA mechanism which maximizes the throughput. In the case of a low packet transmission rate of the application layer, a rate selected from the rate candidate table achieves the maximum throughput and the same (or similar) PER. Power consumption for the rate selected from the rate candidate table is lower a power consumption for a rate selected by adopting the RA mechanism which maximizes the throughput.

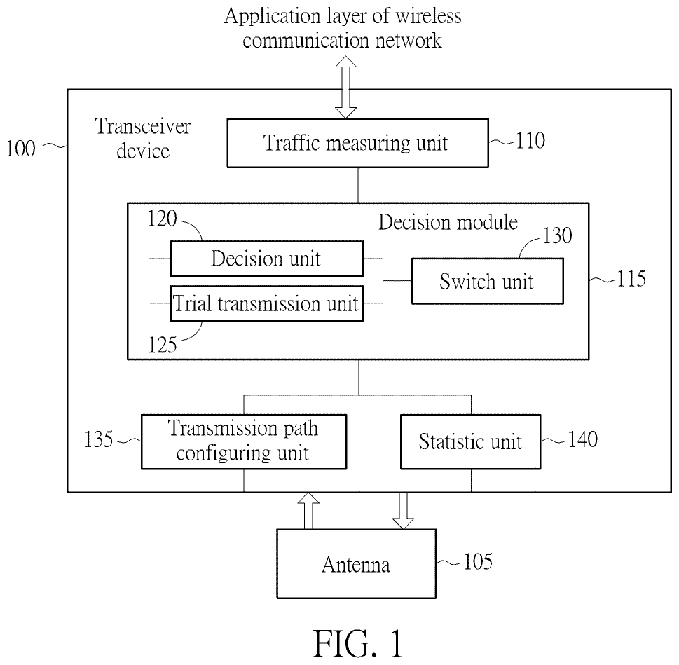

Refer to FIG. 1. FIG. 1 is a block schematic diagram of a transceiver device 100 in a wireless communication network according to an example of the present invention. It should be noted that the units in FIG. 1 can be implemented by software, hardware, firmware or a combination of the devices mentioned above. For example, the transceiver device 100 may be a circuit device which is enabled to perform a software program or a firmware program. The transceiver device 100 is coupled to an antenna 105 and the application layer of the wireless communication network, and comprises a traffic measuring unit 110, a decision module 115, a transmission path configuring unit 135 and a statistic unit 140. The decision module 115 comprises a decision unit 120, a trial transmission unit 125 and a switch unit 130.

The traffic measuring unit 110 is configured for measuring a packet transmission rate of the application layer of the wireless communication network. The transmission path configuring unit 135 is configured for configuring a transmission circuit number used by the wireless communication network. The statistic unit 140 is coupled to the transmission path configuring unit, and is configured for performing a statistical operation to obtain an average PER of the transceiver device during a first target beacon transmission time (TBTT). The decision module 115 is coupled to the traffic measuring unit, the transmission path configuring unit and the statistic unit, and is configured for controlling the transmission path configuring unit to decrease the transmission circuit number used by the wireless communication network during a second TBTT according to the packet transmission rate and the average PER.

In one example, the decision module 115 performs a first algorithm operation (e.g., an algorithm operation which maximizes the throughput) to adjust a rate of the wireless communication network in order to determine a first rate, and the first rate enables maximizing a throughput of the wireless communication network without increasing the average PER.

In one example, when performing the first algorithm operation, the decision module 115 performs trial transmissions according to different trial rates tp_try_rate (e.g., by using different trial rates tp_try_rate one by one), to check whether a first inequality condition is met:

$$tp\_try \_phy \_rate \times ( 1 - tp\_try \_per ) \geq pre\_phy \_rate \times ( 1 - pre\_per ) \qquad ( Eq . 1 )$$

wherein tp_try_per is an average PER obtained by performing transmissions according to the trial rate tp_try_rate, tp_try_phy_rate is a theoretical maximum rate corresponding to the trial rate tp_try_rate, pre_phy_rate is a theoretical maximum rate corresponding to an actual rate during the first TBTT, and pre_per is the average PER during the first TBTT. The trial rate tp_try_rate corresponding to the average PER tp_try_per is determined as the first rate when the first inequality condition is met.

In one example, the decision module 115 performs a second algorithm operation (e.g., an algorithm operation which saves power) according to the determined first rate for adjusting the rate of the wireless communication network in order to determine a second rate, and the second rate enables decreasing the transmission circuit number used by the wireless communication network while maximizing the throughput of the wireless communication network.

In one example, when the packet transmission rate of the application layer is greater than a rate determined via the second algorithm operation, the decision module 115 deactivates the second algorithm operation and does not decrease the transmission circuit number used by the wireless communication network.

In one example, when performing the second algorithm operation, the decision module 115 performs trial transmissions according to different trial rates ps_try_rate, to check whether a second inequality condition is met:

$$( \frac{{P}_{TX}^{ps \_ try \_ rate} \cdot {TXTIME}^{PS - Try} \cdot ( 1 + ps\_try \_per )}{{TxBit}^{PS - Try}} < \frac{{P}_{TX}^{tp \_ rate} \cdot {TXTIME}^{TP - Try} \cdot ( 1 + tp\_per )}{{TxBit}^{TP - Try}} ) \qquad ( Eq . 2 )$$

wherein tp_per is an average PER obtained by performing the trial transmissions according to the first rate tp_rate when performing the first algorithm operation, ps_try_per is an average PER obtained by performing the trial transmissions according to the trial rates ps_try_rate when performing the second algorithm operation, P_{TX}^{tp_rate} is a total power consumption needed for performing the trial transmissions according to the first rate tp_rate when performing the first algorithm operation, P_{TX}^{ps_try_rate} is a total power consumption needed for performing the trial transmissions according to the trial rates ps_try_rate, TXTIME^{TP-Try} is a total packet transmission time of all transmissions in a trial transmission level of the first algorithm operation, TXTIME^{PS-Try} is a total packet transmission time of all transmissions in a trial transmission level of the second algorithm operation, TxBit^{TP-Try} is a total data bit number of all transmissions in the trial transmission level of the first algorithm operation, and TxBit^{PS-Try} is a total data bit number of all transmissions in the trial transmission level of the second algorithm operation. The trial rate ps_try_rate corresponding to the average PER ps_try_per is determined as the second rate when the second inequality condition is met.

In one example, the decision module 115 adjusts the rate of the wireless communication network from a plurality of candidate rates in a rate candidate table of the second algorithm operation according to the determined first rate in order to determine the second rate.

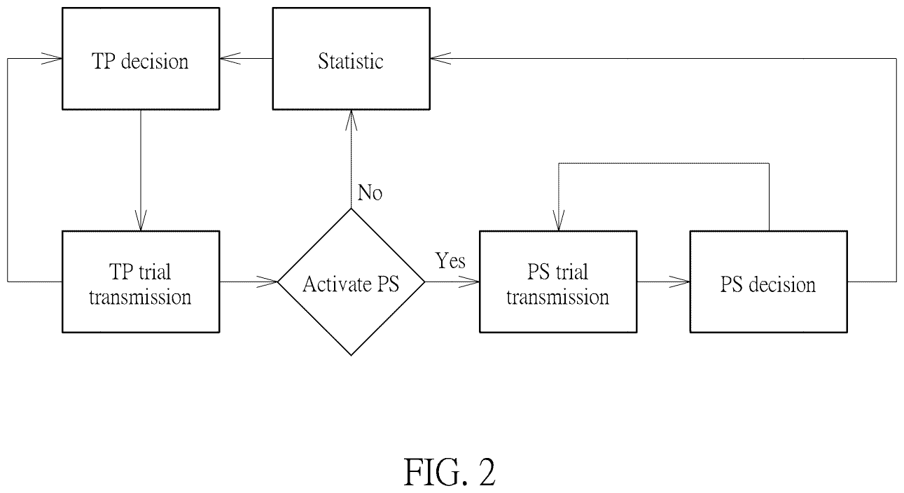

Refer to FIG. 2. FIG. 2 is a schematic diagram of operations of the transceiver device 100 according to an example of the present invention. As shown in FIG. 2, the algorithm mechanism comprises two parts. The first part is a rate adaptive algorithm which maximizes the throughput (i.e., the first algorithm operation), and the second part is a rate adaptive algorithm which saves power (i.e., the second algorithm operation). The sequence of the algorithm is a statistic stage, a TP decision stage, a TP trial transmission stage, a PS trial transmission stage, and a PS decision stage, and then returns to the statistic stage to complete a cycle operation.

In the statistic stage, the statistic unit 140 computes an average PER of performing signal transmission during a TBTT. The PER is provided as an input data to the TP decision stage and the TP trial transmission stage.

The TP decision stage is performed after each TBTT to maximize traffic. During the TP decision stage, the decision unit 120 determines a trial rate tp_try_rate of the trial transmissions performed during the TP trial transmission stage according to the average PER pre_per computed during the statistic stage. The trial transmission unit 125 performs a corresponding trial transmission at the trial rate tp_try_rate. The decision unit 120 determines that the rate tp_try_rate is higher than a rate pre_rate corresponding to the computed average PER pre_per (i.e., increases the rate), is lower than the rate pre_rate (i.e., decreases the rate), or is the same as the rate pre_rate (i.e., does not adjust and maintains the rate).

For example (but not limited to), when the rate pre_rate corresponding to the average PER pre_per is less than a first threshold (e.g., 5%), the decision unit 120 determines to increase the rate, and selects and controls the trial rate tp_try_rate to be higher than the rate pre_rate. When the rate pre_rate corresponding to the average PER pre_per is greater than a second threshold (e.g., 10%), the decision unit 120 selects and controls the trial rate tp_try_rate to be lower than the rate pre_rate.

In practice, if (for example) a rate model corresponding to the rate pre_rate is high efficiency (HE), a 2-way spatial stream, a modulation and coding scheme (MCS) being MCS8 (i.e., 256QAM 3/4), a channel model having a maximum bandwidth 80 MHz and the average PER pre_per being less than 10%, the decision module 120 may increase the trial rate tp_try_rate and determine, for example, that a corresponding rate model is HE, the 2-way spatial stream, the MCS is MCS9 (i.e., 256QAM 5/6) and the channel model has the maximum bandwidth 80 MHz.

In one example, if a rate model corresponding to the rate pre_rate is HE, a 2-way spatial stream, a MCS being MCS7 (i.e., 64QAM 5/6), a channel model having a maximum bandwidth 80 MHz and the average PER pre_per being greater than 10%, the decision module 120 may decrease the trial rate tp_try_rate and determine, for example, that a corresponding rate model is HE, the 2-way spatial stream, the MCS is MCS6 (i.e., 64QAM 3/4), and the channel model has the maximum bandwidth 80 MHz, to decrease the rate in order to control the average PER to be equal to or less than 10%. In this way, a rate model with a highest rate is selected for transmissions while maintaining the average PER as equal to or less than 10%. For example, but not limited to, when a signal quality of a channel environment is acceptable, a rate corresponding to the 2-way spatial stream (i.e., adopting two antennas or adopting two transmission circuits) is usually selected for transmissions.

In the TP trial transmission stage, the trial transmission unit 125 uses the determined trial rate tp_try_rate to perform the trial transmissions, and performs a next stage. The switch unit 130 determines and confirms whether to active the PS-RA mechanism. If the switch unit 130 determines not to active the PS-RA mechanism, the statistic stage is entered. The statistic unit 140 performs a statistical operation of the average PER during a next TBTT. In contrast, if the switch unit 130 determines to active the PS-RA mechanism, the PS trial transmission stage is entered. Specifically (but not limited to), when the determined trial rate tp_try_rate meets the equation (Eq. 1) and the packet transmission rate of the application layer is not too high, the switch unit 130 activates the corresponding PS-RA mechanism.

When the inequality condition (Eq. 1) is met, the trial transmission unit 125 configures a rate tp_rate which maximizes the throughput as the trial rate tp_try_rate. In not, the trial transmission unit 125 continues to select other trial rates to perform the trial transmissions, and determines whether the other trial rate meets the equation (Eq. 1). At this time, tp_try_rate is a trial rate used by the rate adaptive algorithm operation which maximizes the throughput (throughput rate adaptation (TP-RA)) (i.e., the first algorithm operation).

In practice, in one example, e.g. after each TBTT ends, the traffic measuring unit 110 checks a packet transmission rate of an application layer during the statistic stage (e.g., measures the packet transmission rate by checking an amount of data transmitted from the application layer to a data buffer of a physical layer). If the packet transmission rate is higher than an output transmission rate expected to be supported by the rate candidate table of the PS-RA algorithm, the switch unit 130 deactivates the PS trial transmission stage and the PS decision stage. The process continues to directly perform the statistic stage. In contrast, if the packet transmission rate is lower than an output transmission rate expected to be supported by the rate candidate table of the PS-RA algorithm, it is expected that the PS-RA algorithm supports the packet transmission rate. Thus, the switch unit 130 activates the PS trial transmission stage and the PS decision stage.

The switch unit 130 determines whether to activate the PS-RA algorithm according to whether the inequality condition which maximizes the throughput is met and whether the packet transmission rate is lower than an output transmission rate expected to be supported. Thus, when the switch unit 130 activates the PS-RA algorithm, it is ensured that a throughput corresponding to a rate adjusted by the PS-RA algorithm is the same as a throughput obtained by the TP-RA algorithm.

For example, assuming that a rate tp_rate ultimately determined under a maximum throughput during a first TBTT corresponds to a first rate model, a rate determined in the PS decision stage corresponds to a second rate model. The difference between the first rate model and the second rate model may only be the number of activated transmission circuits. Then, the process returns to the statistic stage. Transmissions are performed according to the second rate model during a second TBTT, and a statistical operation is performed to obtain a corresponding average PER. Then, in the TP decision stage, it is determined whether a theoretical rate of the second rate model actually supports a packet generation rate of the application layer. If yes, the PS-RA algorithm is activated. If no, the PS-RA algorithm is deactivated and the TP-RA algorithm is adopted.

Specifically (but not limited to), the trial transmission 125 determines whether the equation which maximizes the throughput is met when performing the trial transmissions, by performing the trial transmissions N times (e.g., 3 times) according to the trial rate tp_try_rate. The trial transmission 125 records the average PER tp_try_per of the 3 trial transmissions and a corresponding power consumption, and determines whether the first inequality condition is met. If the first inequality condition (Eq. 1) is met, the TP trial transmission stage is terminated. An ultimately determined rate tp_rate is equal to a currently selected rate tp_try_rate. An average PER tp_per corresponding to the ultimately determined rate tp_rate is equal to an average PER corresponding to the currently selected rate tp_try_rate. If the first inequality condition is not met, the rate tp_rate is configured as the rate pre_rate used during a previous TBTT. In the PS trial transmission stage, a rate which saves power is selected from multiple candidate rates according to the second inequality condition (Eq. 2).

In the PS trial transmission stage PS-Try, the trial transmission unit 125 selects N (e.g., at most 3) candidate rates from the rate candidate table of the PS-RA algorithm according to the rate tp_rate, uses the candidate rates one by one to perform the trial transmissions, and records a total packet transmission time, an average PER and a total data bit number of the trial transmissions.

In the PS decision stage, the decision unit 120 determines whether the trial rate ps_try_rate aiming at power saving becomes an ultimate rate ps_rate aiming at power saving, and adopts the second inequality condition to compare a power consumption per unit bit of the rate tp_rate and the rate ps_try_rate. If the second inequality condition is met, the PS trial transmission stage PS-Try is terminated, and the ultimate rate ps_rate aiming at power saving is configured equal to the currently selected trial rate tp_try_rate. If the second inequality condition is not met, the trial transmission 125 selects a next candidate rate to perform the determination. If none of the selected 3 candidate rates enable the second inequality condition to be met, the ultimate rate ps_rate aiming at the power saving is configured as the rate tp_rate aiming at maximizing the throughput. In this way, a number of transmission circuits to be activated is determined according to a spatial stream number indicated by a rate model corresponding to the ultimate rate ps_rate aiming at power saving. For example, one transmission circuit is activated if there is a 1-way spatial stream, and two transmission circuits are activated if there is a 2-way spatial stream. Finally, the ultimate rate ps_rate aiming at power saving is used for transmissions, and the statistic stage for a next TBTT is performed. It should be noted that the second inequality condition being met means that a power consumption per unit bit for a rate determined by the PS-RA algorithm is lower than a power consumption per unit bit for a rate determined by the TP-RA algorithm.

In practice, for example (but not limited to), when a candidate rate is selected as a trial rate from the rate candidate table of the PS-RA algorithm, in the PS trial transmission stage, the trial transmission unit 125 looks up the rate candidate table in order to obtain a trial rate ps_try_rate according to the rate tp_rate which maximizes the throughput. This is input to the rate candidate table, to determines whether an average power consumption per bit for the trial rate ps_try_rate is lower than an average power consumption per bit for the rate tp_rate which maximizes the throughput.

Examples of the present invention establish multiple candidate rates in the rate candidate table according to stability and power saving. In one example, different channel models are simulated offline to find a signal-to-noise ratio (SNR) table for different rates. For example, for the channel model B, the following table is measured or obtained (taking the MCS MCS0-MCS3 as an example) Under the channel model B, when the MCS is MCS0, a 1-way spatial stream and an error correction code (ECC) is a BCC coding, and the SNR during a reception is 2 dB.

| | Channel | | Channel | | Channel | | Channel | |
|---|---|---|---|---|---|---|---|---|
| | model B | | model B | | model B | | model B | |
| | 1-way spatial | | 1-way spatial | | 2-way spatial | | 2-way spatial | |
| | stream | | stream | | stream | | stream | |
| | BCC coding | | LDPC coding | | BCC coding | | LDPC coding | |
| MCS0 | 2 | (dB) | 1 | (dB) | 3 | (dB) | 1 | (dB) |
| MCS1 | 6 | (dB) | 4 | (dB) | 8 | (dB) | 6 | (dB) |
| MCS2 | 11 | (dB) | 9 | (dB) | 11 | (dB) | 9 | (dB) |
| MCS3 | 11 | (dB) | 10 | (dB) | 15 | (dB) | 14 | (dB) |

For example (but not limited to), assuming that the TP-RA algorithm selects the MCS MCS3 with the 2-way spatial stream and the LDPC coding, the PS-RA algorithm expects to select the MCS MCS1/MCS2/MCS3 with the 1-way spatial stream and the LDPC coding to perform the trial transmissions, in order to save power. One less transmission circuit is activated by decreasing the number of spatial streams. Thus, the power is significantly saved. For example, the SNR is 10 dB under the channel model B by adopting the MCS MCS3 with the 1-way spatial stream and the LDPC coding. Compared to the MCS MCS3 with the 2-way spatial stream and the LDPC coding, the SNR under channel model B is 14 dB, which is 4 dB less. However, a transmission power for the 1-way spatial stream is relatively lower than a transmission power for the 2-way spatial stream. Thus, an impact of the reduction in transmission power is compensated, and a signal transmission robustness is achieved. Similarly, there is a similar phenomenon by adopting the MCS MCS2/MCS1 or MSC0 with the 1-way spatial stream and the LDPC coding.

The table needed by the PS-RA algorithm is organized as follows according to data in the above table (taking the 2-way spatial stream as an example, but not limited therein):

| Input rate | Candidate rate 1 | Candidate rate 2 | Candidate rate 3 |
|---|---|---|---|
| 2-way spatial | 1-way spatial | | |
| stream/MCS0 | stream/MCS0 | | |
| 2-way spatial | 1-way spatial | 1-way spatial | |
| stream/MCS1 | stream/MCS1 | stream/MCS0 | |
| 2-way spatial | 1-way spatial | 1-way spatial | 1-way spatial |
| stream/MCS2 | stream/MCS2 | stream/MCS0 | stream/MCS0 |
| 2-way spatial | 1-way spatial | 1-way spatial | 1-way spatial |
| stream/MCS3 | stream/MCS3 | stream/MCS2 | stream/MCS1 |

For example, when the TP-RA algorithm selects a specific MCS (e.g., MCS3) with an M-way spatial stream and a specific coding, wherein M is greater than or equal to 2, the candidate rate used by the PS-RA algorithm is less than the M-way spatial stream and a second MCS is the same as the specific MCS. The modulation scheme of the second MCS is the same as or simpler than the modulation scheme of the specific MCS. For example, the modulation schemes of the MCSs MCS0, MCS1 and MCS2 are simpler than the modulation scheme of the MCS MCS3. For example, when the input rate corresponds to the 2-way spatial stream and the MCS MCS0, the candidate rate corresponds to the 1-way spatial stream and the MCS MCS0. When the input rate corresponds to the 2-way spatial stream and the MCS MCS1, the candidate rate corresponds to the 1-way spatial stream and the MCS MCS1 or MCS0. When the input rate corresponds to the 2-way spatial stream and the MCS MCS2, the candidate rate corresponds to the 1-way spatial stream and the MCS MCS2, MCS1 or MCS0. When the input rate corresponds to the 2-way spatial stream and the MCS MCS3, the candidate rate corresponds to the 1-way spatial stream and the MCS MCS3, MCS2 or MCS1. In this example, the number of the candidate rates is at most 3, thus the candidate rate corresponding to the 1-way spatial stream and the MCS MCS0 is dropped. Similarly, in other examples, when the input rate corresponds to the 2-way spatial stream and the MCS MCS4, the candidate rate corresponds to the 1-way spatial stream and the MCS MCS4, MCS3 or MCS2. In other examples, the coding scheme corresponding to the candidate rates used by the PS-RA algorithm may be different from the coding scheme corresponding to the rates determined by the TP-RA algorithm. This variation is also consistent with the spirit of the invention.

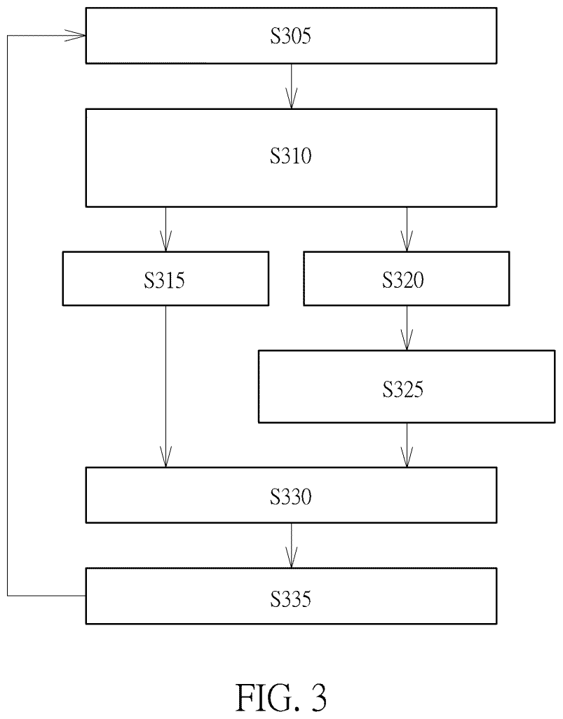

Refer to FIG. 3 in conjunction with FIG. 1. FIG. 3 is a schematic diagram of operations corresponding to the transceiver device 100 in FIG. 1 according to an example of the present invention. The transceiver device 100 is applied in a physical layer of a Wi-Fi network. The transceiver device 100 receives a packet via the antenna 105, and demodulates the packet. The transceiver device 100 transmits a packet via the antenna 105 to other nodes in the Wi-Fi network. In addition, the transceiver device 100 is located on the physical layer and is between the antenna 105 and an application layer. The application layer is above the physical layer.

In step S305, the transceiver device 100 receives an acknowledgement or a block Acknowledgement from a transmitter device via the antenna 105, and transmits (or notifies) the acknowledgement or the block Acknowledgement to the statistic unit 140, so that the statistics unit 140 performs the statistical operation on the PER.

In step S310, after each TBTT, the traffic measuring unit 110 performs the statistical operation to obtain a PER of data transmitted from the application layer to the physical layer during each TBTT, and transmits the measured PERs to the switch unit 130. The statistic unit 140 performs a statistical operation to obtain an average PER during the TBTT (e.g., performs the statistical operation on data in the received modulated packet to generate the average PER), and transmits (or notifies) the average PER to the decision unit 120.

In step S315, the switch unit 130 determines whether to activate the PS-RA algorithm operation according to the measured packet transmission rate.

In step S320, the decision unit 120 performs operations of the TP decision stage in the TP-RA algorithm operation. In the step S325, the trial transmission unit 125 performs operations of the TP trial transmission stage in the TP-RA algorithm operation, controls the spatial stream number (i.e., the transmission circuit number) used by the transmission path configuring unit 135, and notifies the statistic unit 140 to perform the statistical operations of the TP trial transmission stage in the TP-RA algorithm operation to obtain the average PER and the average power consumption.

In step S330, when the switch unit 130 activates the PS-RA algorithm operation, the trial transmission 125 performs operations of the PS trial transmission stage in the PS-RA algorithm operation.

In step S335, after the trial transmission 125 performs the operations of the PS trial transmission stage, the decision unit 120 performs operations of the PS decision stage, and controls the spatial stream number (i.e., the transmission circuit number) used by the transmission path configuring unit 135 during the next TBTT. Then, operations of the statistic stage and transmissions during the next TBTT are performed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transceiver device in a wireless communication network, comprising:
a traffic measuring unit, for measuring a packet transmission rate of an application layer of the wireless communication network;
a transmission path configuring unit, for configuring a transmission circuit number used by the wireless communication network;
a statistic unit, coupled to the transmission path configuring unit, for performing a statistical operation to obtain an average packet error rate (PER) of the transceiver device during a first target beacon transmission time (TBTT); and
a decision module, coupled to the traffic measuring unit, the transmission path configuring unit and the statistic unit, for controlling the transmission path configuring unit to decrease the transmission circuit number used by the wireless communication network during a second TBTT according to the packet transmission rate and the average PER.

2. The transceiver device of claim 1, wherein the decision module performs a first algorithm operation to adjust a rate of the wireless communication network in order to determine a first rate, and the first rate enables maximizing a throughput of the wireless communication network without increasing the average PER.

3. The transceiver device of claim 2, wherein when performing the first algorithm operation, the decision module performs trial transmissions according to different trial rates tp_try_rate, to check whether a first inequality condition is met:
tp_try_phy_rate×(1−tp_try_per)≥pre_phy_rate×(1−pre_per),
wherein tp_try_per is an average PER obtained by performing transmissions according to the trial rate tp_try_rate, tp_try_phy_rate is a theoretical maximum rate corresponding to the trial rate tp_try_rate, pre_phy_rate is a theoretical maximum rate corresponding to an actual rate during the first TBTT, pre_per is the average PER during the first TBTT, and the trial rate tp_try_rate corresponding to the average PER tp_try_per is determined as the first rate when the first inequality condition is met.

4. The transceiver device of claim 2, wherein the decision module performs a second algorithm operation according to the determined first rate for adjusting the rate of the wireless communication network in order to determine a second rate, and the second rate enables decreasing the transmission circuit number used by the wireless communication network while maximizing the throughput of the wireless communication network.

5. The transceiver device of claim 4, wherein when the packet transmission rate of the application layer is greater than a rate determined via the second algorithm operation, the decision module deactivates the second algorithm operation and does not decrease the transmission circuit number used by the wireless communication network.

6. The transceiver device of claim 4, wherein when performing the second algorithm operation, the decision module performs trial transmissions according to different trial rates ps_try_rate, to check whether a second inequality condition is met:
$$( \frac{{P}_{TX}^{ps \_ try \_ rate} \cdot {TXTIME}^{PS - Try} \cdot ( 1 + ps\_try \_per )}{{TxBit}^{PS - Try}} < \frac{{P}_{TX}^{tp \_ rate} \cdot {TXTIME}^{TP - Try} \cdot ( 1 + tp\_per )}{{TxBit}^{TP - Try}} ) ,$$
wherein tp_per is an average PER obtained by performing the trial transmissions according to the first rate tp_rate when performing the first algorithm operation, ps_try_per is an average PER obtained by performing the trial transmissions according to the trial rates ps_try_rate when performing the second algorithm operation, P_{TX}^{tp_rate} is a total power consumption needed for performing the trial transmissions according to the first rate tp_rate when performing the first algorithm operation, P_{TX}^{ps_try_rate} is a total power consumption needed for performing the trial transmissions according to the trial rates ps_try_rate, TXTIME^{TP-Try} is a total packet transmission time of all transmissions in a trial transmission level of the first algorithm operation, TXTIME^{PS-Try} is a total packet transmission time of all transmissions in a trial transmission level of the second algorithm operation, TxBit^{TP-Try} is a total data bit number of all transmissions in the trial transmission level of the first algorithm operation, TxBit^{PS-Try} is a total data bit number of all transmissions in the trial transmission level of the second algorithm operation, and the trial rate ps_try_rate corresponding to the average PER ps_try_per is determined as the second rate when the second inequality condition is met.

7. The transceiver device of claim 4, wherein the decision module adjusts the rate of the wireless communication network from a plurality of candidate rates in a comparison table of the second algorithm operation according to the determined first rate in order to determine the second rate.

8. An operation method for a transceiver device in a wireless communication network, comprising:
measuring a packet transmission rate of an application layer of the wireless communication network;
configuring a transmission circuit number used by the wireless communication network;
performing a statistical operation to obtain an average packet error rate (PER) of the transceiver device during a first target beacon transmission time (TBTT); and
decreasing the transmission circuit number used by the wireless communication network during a second TBTT according to the packet transmission rate and the average PER.

9. The operation method of claim 8, further comprising:
performing a first algorithm operation to adjust a rate of the wireless communication network in order to determine a first rate;
wherein the first rate enables maximizing a throughput of the wireless communication network without increasing the average PER.

10. The operation method of claim 9, further comprising:
when performing the first algorithm operation, performing trial transmissions according to different trial rates tp_try_rate, to check whether a first inequality condition is met:
$$tp\_try \_phy \_rate \times ( 1 - tp\_try \_per ) \geq pre\_phy \_rate \times ( 1 - pre\_per ) ,$$
wherein tp_try_per is an average PER obtained by performing transmissions according to the trial rate tp_try_rate, tp_try_phy_rate is a theoretical maximum rate corresponding to the trial rate tp_try_rate, pre_phy_rate is a theoretical maximum rate corresponding to an actual rate during the first TBTT, pre_per is the average PER during the first TBTT, and the trial rate tp_try_rate corresponding to the average PER tp_try_per is determined as the first rate when the first inequality condition is met.

11. The operation method of claim 9, further comprising:
performing a second algorithm operation according to the determined first rate for adjusting the rate of the wireless communication network in order to determine a second rate;
wherein the second rate enables decreasing the transmission circuit number used by the wireless communication network while maximizing the throughput of the wireless communication network.

12. The operation method of claim 11, further comprising:
when the packet transmission rate of the application layer is greater than a rate determined via the second algorithm operation, deactivating the second algorithm operation and not decreasing the transmission circuit number used by the wireless communication network.

13. The operation method of claim 11, further comprising:
when performing the second algorithm operation, performing trial transmissions according to different trial rates ps_try_rate, to check whether a second inequality condition is met:
$$( \frac{{P}_{TX}^{ps \_ try \_ rate} \cdot {TXTIME}^{PS - Try} \cdot ( 1 + ps\_try \_per )}{{TxBit}^{PS - Try}} < \frac{{P}_{TX}^{tp \_ rate} \cdot {TXTIME}^{TP - Try} \cdot ( 1 + tp\_per )}{{TxBit}^{TP - Try}} ) ,$$
wherein tp_per is an average PER obtained by performing the trial transmissions according to the first rate tp_rate when performing the first algorithm operation, ps_try_per is an average PER obtained by performing the trial transmissions according to the trial rates ps_try_rate when performing the second algorithm operation, P_{TX}^{tp_rate} is a total power consumption needed for performing the trial transmissions according to the first rate tp_rate when performing the first algorithm operation, P_{TX}^{ps_try_rate} is a total power consumption needed for performing the trial transmissions according to the trial rates ps_try_rate, TXTIME^{TP-Try} is a total packet transmission time of all transmissions in a trial transmission level of the first algorithm operation, TXTIME^{PS-Try} is a total packet transmission time of all transmissions in a trial transmission level of the second algorithm operation, TxBit^{TP-Try} is a total data bit number of all transmissions in the trial transmission level of the first algorithm operation, TxBit^{PS-Try} is a total data bit number of all transmissions in the trial transmission level of the second algorithm operation, and the trial rate ps_try_rate corresponding to the average PER ps_try_per is determined as the second rate when the second inequality condition is met.

14. The operation method of claim 11, further comprising:
adjusting the rate of the wireless communication network from a plurality of candidate rates in a comparison table of the second algorithm operation according to the determined first rate in order to determine the second rate.
